(19) United States
(12) Patent Application Publication
(10) Pub. No.: US 2016/0143253 A1
(43) Pub. Date: May 26, 2016

(54) LEASH DEVICE

(71) Applicant: Paul Pawlowski, Monroe Township, NJ (US)

(72) Inventor: Paul Pawlowski, Monroe Township, NJ (US)

(21) Appl. No.: 14/551,298

(22) Filed: Nov. 24, 2014

(51) Int. Cl. A01K 27/00

(52) U.S. Cl. CPC A01K 27/004

(57) ABSTRACT

A leash assembly includes a housing structured to define a handle portion extending away from a spool portion. A spool is rotatably positioned within the spool portion of the housing. A leash is coupled to the spool. The leash is selectively extendable outwardly from the housing and retractable inwardly to the housing. The leash is selectively coupled to an animal. A knob is coupled to the spool such that the knob is positioned outside of the housing. The knob is selectively rotated by the user. The knob is respectively tightened toward the housing and loosened away from the housing. A disk is coupled between the knob and the housing. The disk frictionally engages the spool when the knob is tightened toward the housing and slips on the spool when the knob is loosened away from the housing.

### BACKGROUND OF THE DISCLOSURE

### Field of the Disclosure

The disclosure relates to leash devices and more particularly pertains to a new leash device for producing a selectable amount of drag on the leash.

### SUMMARY OF THE DISCLOSURE

An embodiment of the disclosure meets the needs presented above by generally comprising a housing structured to define a handle portion extending away from a spool portion. A spool is rotatably positioned within the spool portion of the housing. A leash is coupled to the spool. The leash is selectively extendable outwardly from the housing and retractable inwardly to the housing. A distal end of the leash with respect to the spool is selectively coupled to an animal giving the user control over the animal. A knob is coupled to the spool such that the knob is positioned outside of the housing. The knob is rotated by the user. The knob is respectively tightened toward the housing and loosened away from the housing. A disk is coupled between the knob and the housing. The disk frictionally engages the spool when the knob is tightened toward the housing. Thus, a rotation applied to the spool by the leash is inhibited. The disk slips on the spool when the knob is loosened away from the housing. Thus, the rotation applied to the spool by the leash is uninhibited.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left perspective view of a leash assembly according to an embodiment of the disclosure.

FIG. 2 is a right perspective view of an embodiment of the disclosure.

FIG. 3 is a left side view of an embodiment of the disclosure.

FIG. 4 is a cross sectional view taken along line 4-4 of FIG. 3 of an embodiment of the disclosure.

FIG. 5 is a back view of an embodiment of the disclosure.

FIG. 6 is an in-use view of an embodiment of the disclosure.

### DESCRIPTION OF THE PREFERRED EMBODIMENT

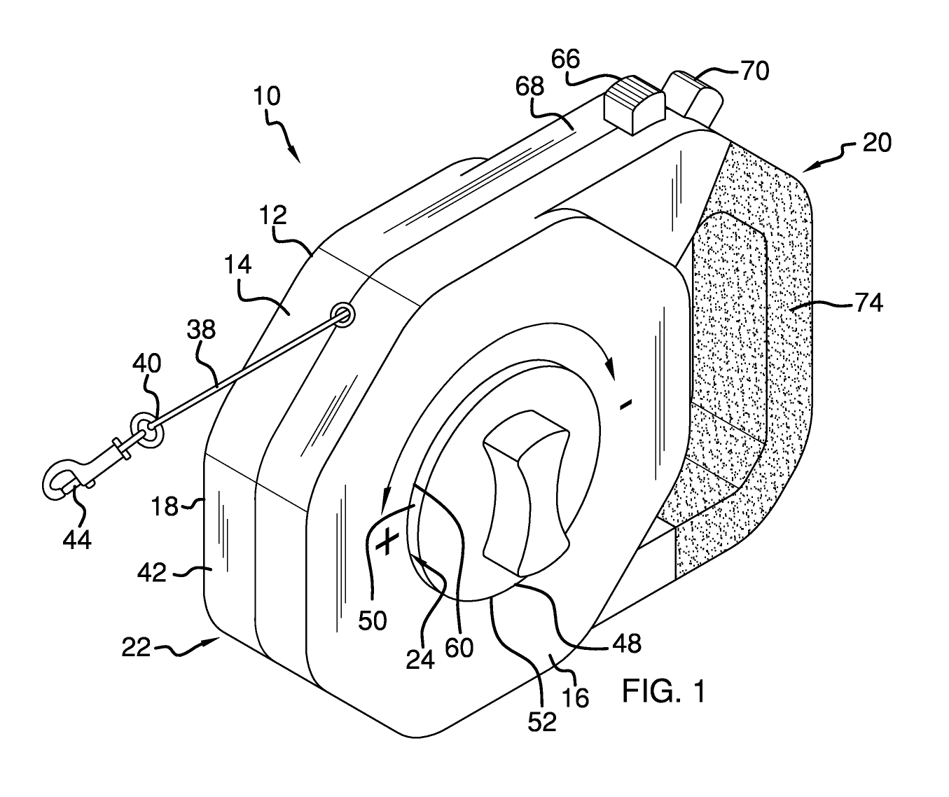

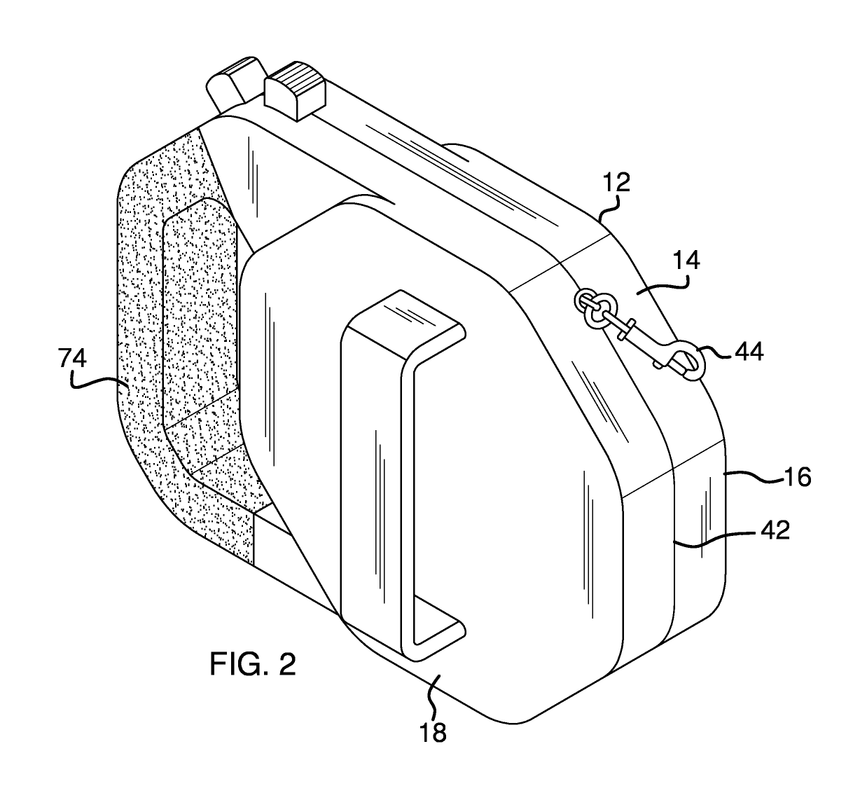

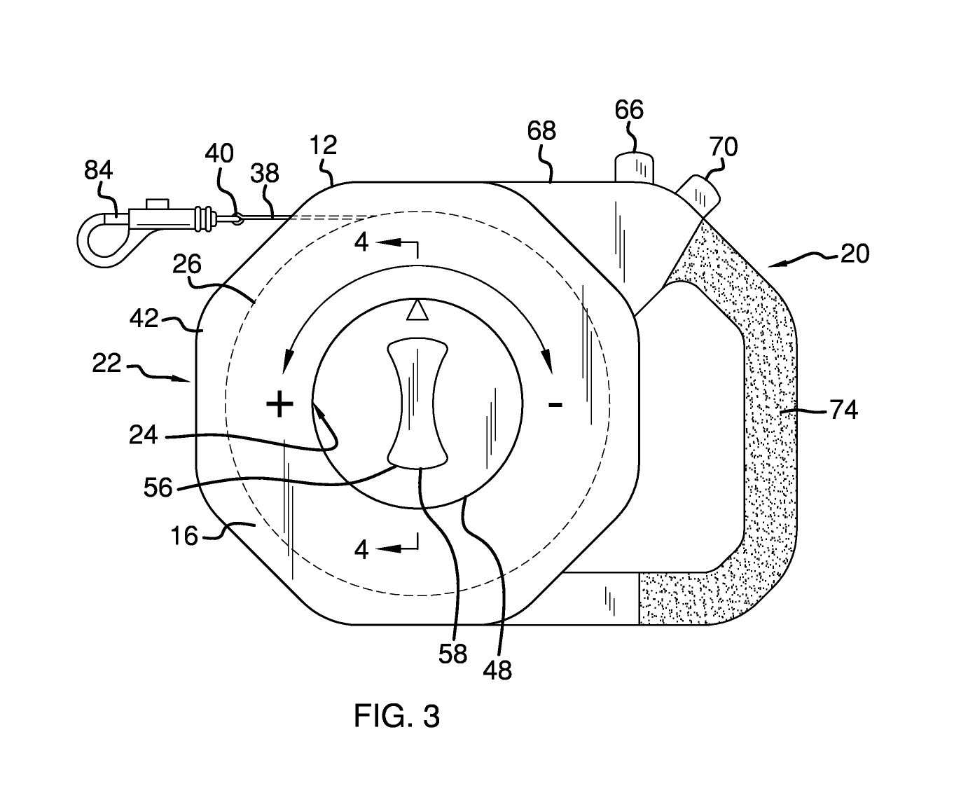

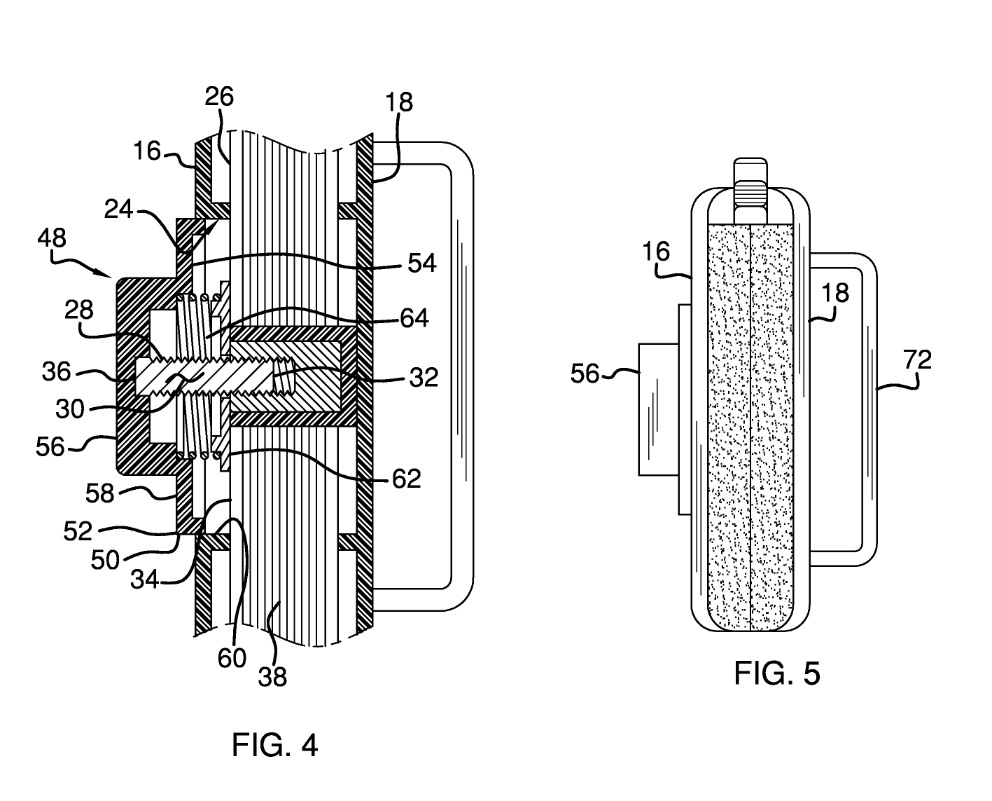

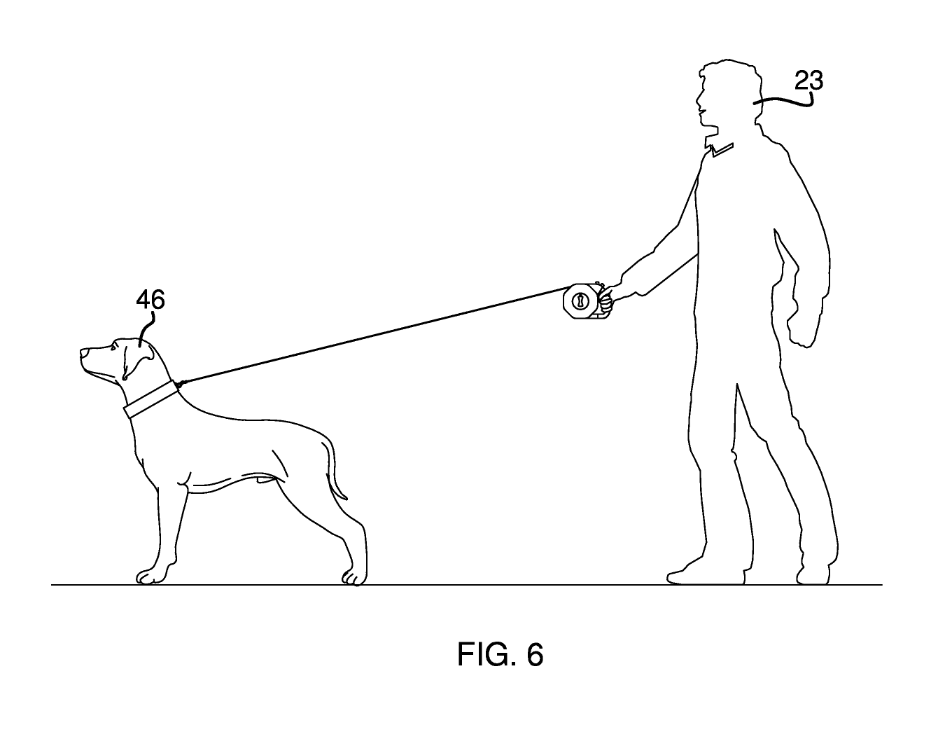

With reference now to the drawings, and in particular to FIGS. 1 through 6 thereof, a new leash device embodying the principles and concepts of an embodiment of the disclosure and generally designated by the reference numeral 10 will be described.

As best illustrated in FIGS. 1 through 6, the leash assembly 10 generally comprises a housing 12. The housing 12 comprises an outer edge 14 extending between each of a first lateral wall 16 and a second lateral wall 18 of the housing 12. The outer edge 14 of the housing 12 is structured to define a handle portion 20 extending away from a spool portion 22 such that the handle portion 20 may be gripped by a user 23. The first lateral wall 16 of the housing 12 relating to the spool portion 22 has a knob aperture 24 extending therethrough.

A spool 26 is rotatably positioned within the spool portion 22 of the housing 12. A shaft 28 is provided. An outer surface 30 of the shaft 28 is threaded. A first end 32 of the shaft 28 extends into to a first oblique side 34 of the spool 26 such that a second end 36 of the shaft 28 is directed outwardly from the knob aperture 24. The shaft 28 is selectively threadable inwardly to the first oblique side 34 of the spool 26 and outwardly from the first oblique side 34 of the spool 26.

A leash 38 is coupled to and wrapped around the spool 26. A distal end 40 of the leash 38 with respect to the spool 26 extends outwardly from a front side 42 of the outer edge 14 of the housing 12 related to the spool portion 22. The leash 38 is selectively extendable outwardly from the housing 12 and retractable inwardly to the housing 12. A clip 44 is coupled to the distal end 40 of the leash 38. The clip 44 is selectively coupled to an animal 46 such that the user 23 maintains control over the animal 46.

A knob 48 is provided. The knob 48 has a lip 50 coupled to and extending laterally away from an outermost edge 52 of a first flanking side 54 of the knob 48. A grip 56 is coupled to a second flanking side 58 of the knob 48. The first flanking side 54 of the knob 48 is coupled to the second end 36 of the shaft 28. Thus, the knob 48 selectively threads the shaft 28 inwardly and outwardly from the spool 26. The knob 48 is positioned within the knob aperture 24 such that the lip 50 is positioned adjacent to a bounding edge 60 of the knob aperture 24.

A disk 62 is provided. The shaft 28 extends through the disk 62 such that the disk 62 freely spins on the shaft 28. The disk 62 is positioned between the first flanking side 54 of the knob 48 and the first oblique side 34 of the spool 26. A spring biasing member 64 is positioned between the first flanking side 54 of the knob 48 and the disk 62. Thus, the spring biasing member 64 biases the disk 62 toward the first oblique side 34 of the spool 26. The disk 62 frictionally engages the first oblique side 34 of the spool 26 when the shaft 28 is threaded inwardly into the first oblique side 34 of the spool 26. Consequently, a rotation applied to the spool 26 by the leash 38 is inhibited. The disk 62 slips on the first oblique side 34 of the spool 26 when the shaft 28 is threaded outwardly from the first oblique side 34 of the spool 26. Thus, the rotation applied to the spool 26 by the leash 38 is uninhibited.

A brake 66 is movably coupled to the outer edge 14 of the housing 12 relating to the handle portion 20. The brake 66 is positioned on a top side 68 of the outer edge 14 of the housing 12. The brake 66 is mechanically coupled to the spool 26 such that the spool 26 is prevented from rotating when the brake 66 is engaged. A release 70 is movably coupled to the top side 68 of the outer edge 14 of the housing 12 relating to the handle portion 20. The release 70 is mechanically coupled to the brake 66 such that the release 70 disengages the brake 66 from the spool 26 when the release 70 is engaged. Thus, the brake 66 does not prevent the spool 26 from rotating.

A grasp 72 is coupled to the second lateral wall 18 of the housing 12 relating to the spool portion 22. The grasp 72 may be gripped. A gripping layer 74 is coupled around the handle portion 20 of the housing 12. The gripping layer 74 improves the user's 24 ability to grip the handle portion 20 of the housing 12.

In use, the knob 48 is tightened so the disk 62 produces a desired amount of drag on the spool 26. The disk 62 absorbs energy produced by the animal 46 if the animal 46 tries to run from the user 23. Thus, the user 23 is not violently jerked when the animal 46 draws the entirety of the leash 38 outwardly from the spool 26. The brake 66 is engaged at any time during use of the assembly 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A leash assembly comprising:
a housing structured to define a handle portion extending away from a spool portion such that said handle portion is configured to be gripped by a user;
a spool rotatably positioned within said spool portion of said housing;
a leash coupled to said spool such that said leash is selectively extendable outwardly from said housing and retractable inwardly to said housing, a distal end of said leash with respect to said spool being configured to be coupled to an animal such that the user maintains control over the animal;
a knob coupled to said spool such that said knob is positioned outside of said housing, said knob being selectively rotated by the user wherein said knob is respectively tightened toward said housing and loosened away from said housing; and
a disk coupled between said knob and said housing, said disk frictionally engaging said spool when said knob is tightened toward said housing wherein a rotation applied to said spool by said leash is inhibited, said disk slipping on said spool when said knob is loosened away from said housing wherein the rotation applied to said spool by said leash is uninhibited.

2. The assembly according to claim 1, wherein said housing comprising an outer edge extending between each of a first lateral wall and a second lateral wall of said housing, said first lateral wall of said housing having a knob aperture extending therethrough.

3. The assembly according to claim 2, further comprising a shaft, an outer surface of said shaft being threaded, a first end of said shaft extending into to a first oblique side of said spool such that a second end of said shaft is directed outwardly from said knob aperture, said shaft being selectively threadable inwardly to said first oblique side of said spool and outwardly from said first oblique side of said spool.

4. The assembly according to claim 3, further comprising said knob being coupled to said second end of said shaft such that said knob selectively threads said shaft inwardly and outwardly from said spool, said knob being positioned within said knob aperture.

5. The assembly according to claim 4, further comprising said shaft extending through said disk such that said disk freely spins on said shaft, said disk being positioned between said knob and said spool.

6. The assembly according to claim 5, further comprising a spring biasing member positioned between said knob and said disk such that said spring biasing member biasing said disk toward said first oblique side of said spool.

7. The assembly according to claim 1, further comprising a brake movably coupled to said handle portion of said housing, said brake being mechanically coupled to said spool such that said spool is prevented from rotating when said brake is engaged.

8. The assembly according to claim 7, further comprising a release movably coupled to said handle portion of said housing, said release being mechanically coupled to said brake such that said release disengages said brake when said release is engaged wherein said brake does not prevent said spool from rotating.

9. A leash assembly comprising:
a housing, said housing comprising an outer edge extending between each of a first lateral wall and a second lateral wall of said housing, said first lateral wall of said housing having a knob aperture extending therethrough, said outer edge of said housing being structured to define a handle portion extending away from a spool portion such that said handle portion is configured to be gripped by a user;
a spool rotatably positioned within said spool portion of said housing;
a shaft, an outer surface of said shaft being threaded, a first end of said shaft extending into to a first oblique side of said spool such that a second end of said shaft is directed outwardly from said knob aperture, said shaft being selectively threadable inwardly to said first oblique side of said spool and outwardly from said first oblique side of said spool;
a leash coupled to said spool such that said leash is selectively extendable outwardly from said housing and retractable inwardly to said housing, a distal end of said leash with respect to said spool being configured to be coupled to an animal such that the user maintains control over the animal;
a knob coupled to said second end of said shaft such that said knob selectively threads said shaft inwardly and outwardly from said spool, said knob being positioned within said knob aperture;
a disk, said shaft extending through said disk such that said disk freely spins on said shaft, said disk being positioned between said knob and said spool;
a spring biasing member positioned between said knob and said disk such that said spring biasing member biases said disk toward said first oblique side of said spool, said disk frictionally engaging said first oblique side of said spool when said shaft is threaded inwardly to said first oblique side of said spool wherein a rotation applied to said spool by said leash is inhibited, said disk slipping on said spool when said shaft is threaded outwardly from said first oblique side of said spool wherein the rotation applied to said spool by said leash is uninhibited;
a brake movably coupled to said handle portion of said housing, said brake being mechanically coupled to said spool such that said spool is prevented from rotating when said brake is engaged; and
a release movably coupled to said handle portion of said housing, said release being mechanically coupled to said brake such that said release disengages said brake when said release is engaged wherein said brake does not prevent said spool from rotating.
